(19) United States
(12) Patent Application Publication
(10) Pub. No.: US 2008/0262674 A1
(43) Pub. Date: Oct. 23, 2008

(54) Data Processing Arrangement and the Operation Mode Thereof

(76) Inventors: Andreas Lindinger, Flozlingen (DE); Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/067,149

(22) PCT Filed: Sep. 12, 2006
(86) PCT No.: PCT/EP2006/066300

§ 371 Date: Jul. 7, 2008

(30) Foreign Application Priority Data
Sep. 19, 2005 (DE) 10 2005 044 703.1

(51) Int. Cl. G07C 5/00

(52) U.S. Cl. 701/35

(57) ABSTRACT

A data processing arrangement, in particular a tachograph for a motor vehicle has a control device and at least one memory. The traceability of an error arising during the data processing arrangement operation can be better guaranteed. At least one partial area of the memory is embodied in the form of a sequence memory and a control device is constructed such that sequences of the data processing arrangement or of the tachograph are recorded in the sequence memory, wherein the sequence memory is provided with at least one ring memory which is organised such that an oldest input is overwritten by a new input, respectively. Thus, it is made possible to record a plurality of sequential events leading to a substantial error in the sequence memory such that the size of the memory is increased within economically acceptable limits during a long operation of the arrangement.

### CROSS-REFERENCE TO RELATED APPLICATIONS

This application is a U.S. national stage application of PCT/EP2006/066300 filed Sep. 12, 2006, which designates the United States of America, and claims priority to German application number 10 2005 044 703.1 filed Sep. 19, 2005, the contents of which are hereby incorporated by reference in their entirety.

### TECHNICAL FIELD

The invention relates to a data processing arrangement, in particular a tachograph for a motor vehicle, comprising a controller and a memory. In addition, the invention relates to a method for the operation of a data processing arrangement of the type mentioned at the beginning.

### BACKGROUND

In the case of tachographs, in particular, there is a compelling need to be able to demonstrate the correct functional progression of operation and possible irregularities. This requirement is particularly important especially in the case of a digital tachograph of relatively recent design according to EEC regulation 3821/85 since digital recordings, in comparison with analog recordings, can be manipulated without leaving any traces. The relevant regulation provides comprehensive measures to counter the manipulation of the data which are intended to be of the nature of legal proof. The recordings of the tachograph themselves are substantially limited to a speed progression over time. Certain defined events are also held in the tachograph's digital mass storage device. These possibilities do not suffice to concretely demonstrate the specific progression of an error or of an attempt at manipulation. One possibility for obtaining more precise knowledge with regard to an irregularity of operation would be to create a so-called log file such as is described for example in the U.S. Pat. No. 5,155,693 B1. One difficulty, however, consists in differentiating irregularities such as may occur comparatively frequently from significant errors which may jeopardize the operational reliability and possibly manipulate recordings. An interaction of relatively small irregularities may possibly cause a significant error in the result, such that the exclusive recording of apparently significant errors does not have to lead to a demonstrability thereof. On the other hand, for relatively long operation of a data processing arrangement, in particular of a tachograph, it is not conceivable to record all irregularities since this would require a disproportionately large memory space.

### SUMMARY

A demonstrability of the arising of errors during operation of a data processing arrangement can be better ensured by an embodiment of a data processing arrangement or a tachograph for a motor vehicle comprising a controller and at least one memory, wherein at least one partial area of the memory is formed as a sequence memory and the controller is formed in such a way that the sequences of the data processing arrangement or of the tachograph are logged in the sequence memory, wherein the sequence memory has at least one ring memory which is organized in circular fashion and is formed in such a way that an oldest entry can be overwritten respectively by a newest entry, and the sequence memory has at least one linear memory which is organized in linear fashion.

According to a further embodiment, the memory may be formed completely as a sequence memory.

According to another embodiment, a method for the operation of a data processing arrangement or a tachograph, comprising a controller and at least one memory, may comprise the steps of: forming at least one partial area of the memory as a sequence memory and logging the sequences of the data processing arrangement or of the tachograph in the sequence memory, wherein the sequence memory has at least one ring memory which is organized in circular fashion and is formed in such a way that the oldest entry is overwritten respectively by the newest entry, and the sequence memory has at least one linear memory which is organized in linear fashion.

According to a further embodiment, the controller may cause errors or irregularities that occur to be permanently registered. According to a further embodiment, entries can be written to the ring memory during the current operation of logical function modules which entries log events of the sequence. According to a further embodiment, an entry may comprise—a time marker,—a feature for identification of the entering logical function module, and—an item of information which makes the event classifiable, in particular an event number uniquely assigned to the event. According to a further embodiment, an entry may comprise a text describing the event. According to a further embodiment, an entry may comprises a line number at which the processing of a program code was situated when the event to be logged took place. According to a further embodiment, an entry may comprise a recording type, which documents what type of an event the recorded event is. According to a further embodiment, the recording type can have various allocations selected from the group consisting of:—a first allocation for documenting what the system makes or what state it has been put into,—a second allocation for documenting a state which indicates an error,—a third allocation for documenting an error whose effects are restricted to an individual module,—a fourth allocation for documenting an error which requires a restart of the overall system,—a fifth allocation for documenting an error which can be rectified only by means of an immediate system start, and—a sixth allocation for documenting that further operation is no longer possible. According to a further embodiment, in the case of specific recording types, the recording of events may change from the ring memory to the linear memory. According to a further embodiment, in the case of an event having a recording type which has the third, fourth or fifth allocation, the recording of events may change from the ring memory to the linear memory. According to a further embodiment, the linear memory may have a specific storage volume and the recording of events is terminated as soon as the storage volume of the linear memory has been filled with new entries. According to a further embodiment, the ring memory may have a write position pointer indicating the current write position. According to a further embodiment, the sequence memory can be read via an interface and has a read position pointer indicating the last read position. According to a further embodiment, in a read operation, for the case where the last write operations took place in the ring memory, the data can be read out from the last read position up to the current write position, and for the case where the last write operations took place in the linear memory, the total content of the sequence memory may be read out. According to a further embodiment, the ring memory and the linear memory in the sequence memory can be separated from one another by means of a variable separation marker. According to a further embodiment, entries entered in the linear memory may have a separate identification.

### BRIEF DESCRIPTION OF THE DRAWINGS

The invention is described below on the basis of a specific exemplary embodiment, without the effect of restricting the invention to said embodiment, with reference to a drawing, in which:

FIG. 1 shows a schematic illustration according to an embodiment.

### DETAILED DESCRIPTION

According to an embodiment, at least one partial area of the memory is formed as a sequence memory and the controller is formed in such a way that the sequences of the tachograph are logged in a sequence memory, wherein the sequence memory has at least one ring memory which is organized in circular fashion and is formed in such a way that the oldest entry is overwritten respectively by the newest entry.

The crucial advantage according to various embodiments is that a multiplicity of sequence events which are possibly harbingers of a significant error can be logged in the sequence memory and the size of the memory nevertheless does not have to exceed economically practical limits even in the case of relatively long operation of the arrangement. The size of the entire sequence memory can expediently be chosen in such a way that a sufficient time before a possible significant error can always be documented sufficiently precisely. A particularly reliable demonstrability of an arising of errors is afforded according to an embodiment if the corresponding memory is formed completely as a sequence memory. In this case, the sequence memory forms a dedicated hardware module and is therefore sufficiently decoupled from the possibly defective function of other components of the arrangement. An embodiment of the sequence memory according to an embodiment is particularly expedient if at least one part of said memory is organized in linear fashion. Such a linear memory prevents the overwriting of particularly significant event information items, which are preferably stored permanently in said memory. Expediently, errors or irregularities that occur can be registered permanently in the sequence memory according to an embodiment in a manner instigated by a controller. In principle, there is the possibility of just one central controller writing entries to the ring sequence memory during current operation. A coordinated writing from different function modules of events which log the sequence to the sequence memory affords advantages with regard to the execution time.

Irregularities can already be demonstrated well on the basis of an inspection of the sequence memory if an entry in each case comprises a time marker, a feature for identification of the entered logical function module and an item of information which makes the event classifiable, in particular allocates an event number uniquely assigned to the event. In addition, an entry can also comprise a text that describes the event in greater detail, which additionally simplifies the interpretation of the content of the sequence memory. In order to eliminate errors, it is expedient, in particular for a targeted alteration of the program code, if an entry comprises a line number at which the processing of a program code was situated when the event to be logged took place. In this way, sequence memory additionally comprises the function of a debugger alongside the manipulation-protecting function.

Further assistance in the interpretation of entries in the sequence memory according to an embodiment is obtained if an entry in each case comprises a recording type, which documents what type of an event the recorded event is. A particularly advantageous breakdown of events into recording types results if provision is made of a first allocation of the recording type for documenting what the system makes or what state it has been put into, a second allocation for documenting a state which indicates an error, a third allocation for documenting an error whose effects are restricted to an individual module, a fourth allocation for documenting an error which requires a restart of the overall system, and a fifth allocation for documenting an error which can be rectified only by means of an immediate system start, and a sixth allocation for documenting that further operation is no longer possible. A classification of events into recording types furthermore has the advantage that the recording of events can change from the ring memory to the linear memory if the recording type indicates that the event to be recorded has a certain significance. In this way, significant events are also still documented in critical function states. In order to limit the outlay for the sequence tracking according to an embodiment, it is expedient for the linear memory to have a specific storage volume. If the controller, during the recording of events in the linear memory, reaches the limits thereof, the entry of further events is terminated. In order to facilitate the data analysis, it is expedient for the ring memory to indicate a current write position by means of a write position pointer. Particularly if the content of the sequence memory can be read out via an interface, it is expedient to hold the last read position by means of an indicating read position pointer in order that, during closely successive analyses of the sequences, for example in the context of eliminating programming errors, it is not always necessary to read out the entire content of the sequence memory in a time-intensive manner. For this purpose, it is particularly expedient that for the case where the last write operations took place in the ring memory, the data are read out from the last read position up to the current write position, and for the case where the last write operations took place in the linear memory, the total content of the sequence memory is read out.

It is particularly expedient to divide the sequence memory into the ring memory and the linear memory if the boundary between these two areas is not fixedly defined, but rather is marked by a dedicated entry. This variable separation marker makes it possible to adapt the memory to the respective requirements. The ring memory essentially differs from the linear memory by virtue of the fact that the addressing order of the individual memory locations causes the memory location having the most significant address to be followed by the one having the least significant address, such that the actually physically linearly constructed memory is cyclically repeatedly rewritten and therefore never becomes full or a limit is never reached. In order that the entries originating from the ring memory and those originating from the linear memory can still be identified with regard to their origin in an entirely satisfactory manner after the read-out, too, it is expedient for entries entered in the linear memory to have a separate identification.

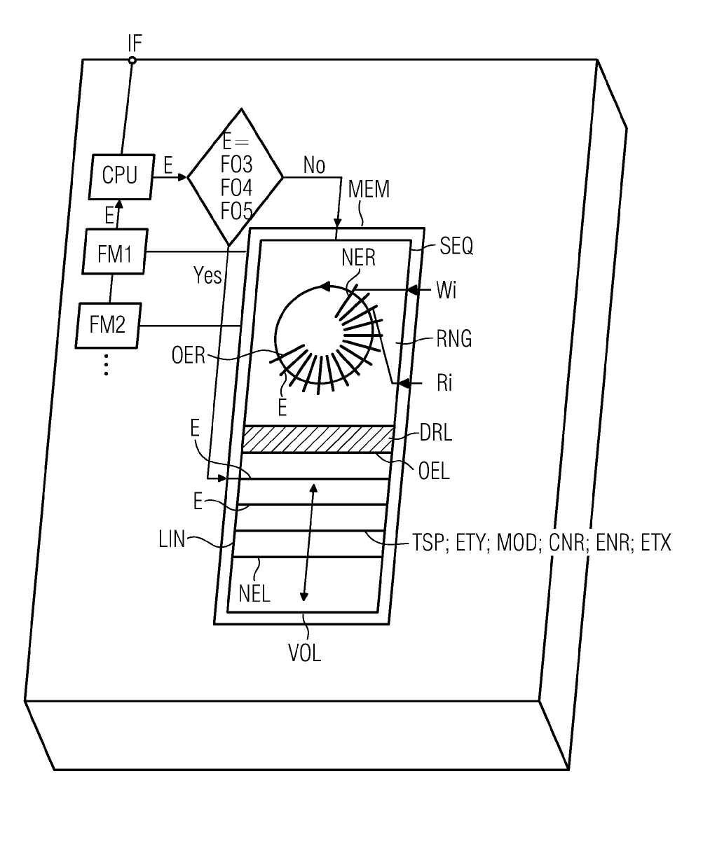

FIG. 1 shows a digital tachograph DTCO, which has a sequence memory SEQ according to an embodiment as part of a memory MEM. The tachograph DTCO comprises a controller CPU, which coordinates the sequences of the tachograph DTCO in general and the reading from and writing to the sequence memory SEQ specifically. The sequence memory SEQ is composed of a ring memory RNG and a linear memory LIN. The ring memory RNG is written to by the controller CPU in such a way that a respective newest entry NER is overwritten by the respective oldest entry OER provided that a complete occupancy has taken place once already. In the linear memory, entries are stored sequentially under the addresses, where the oldest entry OEL in the linear memory is at the least significant address and the newest entry NEL in the linear memory is at the most significant occupied address. The entries document different events E which occur during the operation of individual function modules FM1, FM2. By means of a separate entry, the ring memory RNG is separated from the linear memory LIN in the sense of a separation marker DRL, where the separation marker DRL can be shifted as required by the controller CPU. In this way, the fixed storage volume VOL of the sequence memory SEQ can be optimally utilized. The individual entries of events E in each case comprise a time marker TSP, a recording type ETY, a feature for identification MOD of the recording function module, an event number ENR, a line number CNR in which a corresponding program code was being processed upon the occurrence of the event, and a description ETX of the event. In this case, the recording type ETY documents what type of an event E the recorded event is. For this purpose, the recording type ETY can have various classifying allocations F01-F06, which have the following meanings according to their final digit: documentation of what the system does or what state it has been put into (F01), documentation of a state which indicates an error (F02), documentation of an error whose effects are limited to an individual module (F03), documentation of an error which requires a restart of the overall system (F04), documentation of an error which can only be eliminated by means of an immediate system start step (F05) and documentation that further operation is no longer possible (F06). If an event occurs which has the recording type ETY having an allocation F03, F04 or F05, the controller CPU has the effect that the event E is no longer entered in the ring memory RNG, but rather is entered into the linear memory LIN. The subsequent events E are likewise entered into the linear memory LIN until the latter is fully occupied and the entering of events E is terminated.

In order to read out the recordings from the sequence memory SEQ, the tachograph DTCO has an interface IF. In order to accelerate the write and read operations, the sequence memory is provided with a write position indicator WI and a read position indicator RI. If a plurality of read interrogations are carried out in quick succession, the interface IF transmits only the data volume starting with the read position indicator RI up to the write position indicator WI. The read position indicator is subsequently updated, such that a position is identical to the write position indicator WI.

What is claimed is:

1. A data processing arrangement, or a tachograph for a motor vehicle comprising a controller and at least one memory,
wherein at least one partial area of the memory is formed as a sequence memory and the controller is formed in such a way that the sequences of the data processing arrangement or of the tachograph are logged in the sequence memory, wherein the sequence memory has at least one ring memory which is organized in circular fashion and is formed in such a way that an oldest entry can be overwritten respectively by a newest entry, and the sequence memory has at least one linear memory which is organized in linear fashion.

2. The data processing arrangement according to claim 1, wherein the memory is formed completely as a sequence memory.

3. A method for the operation of a data processing arrangement or a tachograph, comprising a controller and at least one memory,
the method comprising the steps of:
forming at least one partial area of the memory as a sequence memory and logging the sequences of the data processing arrangement or of the tachograph in the sequence memory, wherein the sequence memory has at least one ring memory which is organized in circular fashion and is formed in such a way that the oldest entry is overwritten respectively by the newest entry, and the sequence memory has at least one linear memory which is organized in linear fashion.

4. The method according to claim 3, wherein the controller causes errors or irregularities that occur to be permanently registered.

5. The method according to claim 3, wherein entries are written to the ring memory during the current operation of logical function modules which entries log events of the sequence.

6. The method according to claim 5, wherein an entry comprises
a time marker,
a feature for identification of the entering logical function module, and
an item of information which makes the event classifiable, in particular an event number uniquely assigned to the event.

7. The method according to claim 6, wherein an entry comprises a text describing the event.

8. The method according to claim 3, wherein an entry comprises a line number at which the processing of a program code was situated when the event to be logged took place.

9. The method according to claim 3, wherein an entry comprises a recording type, which documents what type of an event the recorded event is.

10. The method according to claim 9, wherein the recording type can have various allocations selected from the group consisting of:
a first allocation for documenting what the system makes or what state it has been put into,
a second allocation for documenting a state which indicates an error,
a third allocation for documenting an error whose effects are restricted to an individual module,
a fourth allocation for documenting an error which requires a restart of the overall system,
a fifth allocation for documenting an error which can be rectified only by means of an immediate system start, and
a sixth allocation for documenting that further operation is no longer possible.

11. The method according to claim 9, wherein, in the case of specific recording types, the recording of events changes from the ring memory to the linear memory.

12. The method according to claim 11, wherein, in the case of an event having a recording type which has the third, fourth or fifth allocation, the recording of events changes from the ring memory to the linear memory.

13. The method according to claim 3, wherein the linear memory has a specific storage volume and the recording of events is terminated as soon as the storage volume of the linear memory has been filled with new entries.

14. The method according to claim 3, wherein the ring memory has a write position pointer indicating the current write position.

15. The method according to claim 3, wherein the sequence memory can be read via an interface and has a read position pointer indicating the last read position.

16. The method according to claim 3, wherein, in a read operation, for the case where the last write operations took place in the ring memory, the data are read out from the last read position up to the current write position, and for the case where the last write operations took place in the linear memory, the total content of the sequence memory is read out.

17. The method according to claim 3, wherein the ring memory and the linear memory in the sequence memory are separated from one another by means of a variable separation marker.

18. The method according to claim 3, wherein entries entered in the linear memory have a separate identification.

19. A tachograph for a motor vehicle comprising:
a sequence memory having a ring memory and a linear memory, and
a controller operable to log the sequences of the tachograph in the sequence memory,
wherein the ring memory is organized in circular fashion and is formed in such a way that an oldest entry can be overwritten respectively by a newest entry, and the linear memory is organized in linear fashion.
